(19) United States
(12) Patent Application Publication
(10) Pub. No.: US 2004/0157035 A1
(43) Pub. Date: Aug. 12, 2004

(54) Low permeation gaskets

(76) Inventors: Allen R. Guizzetti, Newark, DE (US); James P. Sullivan, Lincoln University, PA (US)

Correspondence Address: W. L. Gore & Associates, Inc., 551 Paper Mill Road, P.O. Box 9206, Newark, DE, 19714-9206, US

(21) Appl. No.: 10/361,918

(22) Filed: Feb. 10, 2003

(51) Int. Cl. B32B 3/02

(52) U.S. Cl. 428/66.6; 428/71; 428/76

(57) ABSTRACT

Low permeation gaskets are formed having low leak rates upon application of low stress sealing conditions. Preferred gaskets comprise a resilient core, a barrier layer having lower permeation to fluids than the core material, and a conformable outer layer for providing a seal at low load and low stress sealing conditions.

### BACKGROUND OF THE INVENTION

A wide variety of gaskets are known for use in sealing applications. In many applications a gasket is used to provide a seal between two flat mating surfaces. An o-ring seal is an example of a gasket typically used to provide a channel seal where low stress to seal is required. In either case, the gasket or o-ring may function to retain fluids at any sealing interface in a system. Where the fluid to be sealed is harmful to the environment, harmful to workers, difficult to clean, or corrosive, it is important that the gasket has sufficient sealability to contain the fluid. Further, a gasket may be required to form a liquid and gas tight seal that is impermeable to fluid transmission at low load and low sealing stress due to system material selection or assembly constraints. Often low load sealing is necessary where assemblies use flexible or low strength components, such as plastics. There are instances where seal integrity is important to retain seal durability; in applications where sealing material is used which reaches a maximum specified compression at relatively low load, increasing the sealing load or stress to the gasket may result in damage to the seal and premature seal failure. Moreover, it is often required that a gasket have resiliency to maintain a sufficient sealing force over varying conditions such as wide temperature ranges, varying flange loads, varying internal pressures, and non-parallel sealing surfaces resulting in varied compression at different areas of the seal.

Gaskets or o-ring seals made from elastomers are examples of very resilient gaskets capable of creating a durable seal over a variety of sealing conditions. However, disadvantageously, elastomeric gaskets and o-rings lack resistance to permeation by liquids and gases in some uses compared to, for example, solid PTFE o-rings in fuel applications. In the automotive industry, conventional elastomeric seals such as FKM and FVMQ are used in fuel systems at connections in the fuel tank sender area, filler neck area, fuel line connections and the like. Conventional elastomeric seals are affordable, however, they are known to permeate fuel above desired limits. It is becoming increasingly more difficult for current fuel systems to meet demanding evaporative emissions criteria. However, fuel emissions may be reduced by lowering fuel permeation through fuel system seals, thereby reducing pollution, improving air quality, protecting the environment, and meeting stricter emissions levels.

It is also known to manufacture seals with permeation resistance. Such seals may have a protective, low permeating layer on a resilient core. For example, U.S. Pat. No. 5,112,664, to Waterland, and U.S. Pat. No. 2,597,976 to Cousins, U.S. Pat. No. 2,580,546 to Hobson, and U.S. Pat. No. 2,859,061 to Reid all teach a gasket having a rubber core and protective outer layer. U.S. Pat. No. 6,418,959 to Kondo teaches a seal for use in fuel systems having a fluoroplastic or nylon over a fluorosilicon or hydrin rubber. Such seals may inhibit vapor permeation, however, where hard plastic materials are used, seals frequently have lower resiliency and obtaining an adequate seal may be difficult due to low conformity of the outer protective layer. Moreover, where protective low permeating layers are thick the resiliency of the seal may be degraded. Thus, obtaining a low leakage seal under low load and low stress conditions with conventional products can be difficult;

It is also known in the art to form a seal by providing a plastic material layer between two elastomeric layers (U.S. Pat. No. 5,551,707 to Pauley et al.). However, any permeation resistance obtained from the plastic layer of the seal may be compromised in applications where, for example, the seal is twisted during installation. Moreover, the sealability and resiliency may be compromised by the middle plastic layer. Where an exemplary seal of U.S. Pat. No. 5,551,707 uses silicone or fluorosilicone as the elastomeric layers, the seal is susceptible to attack by common chemicals and gases.

Thus, there is currently a need for seals that both significantly reduce permeation through the seal, and which display low leakage under low stress to seal conditions. Further, there is a need for low permeating gaskets that can perform well under varying load and environmental conditions over a long period of time.

### SUMMARY OF THE INVENTION

Gaskets of the present invention are both low permeating and have low leak rates, and are able to obtain these characteristics under low flange loads and low stress conditions. Preferred gaskets of the present invention perform similarly to elastomeric gaskets having low leak rates under low sealing stress conditions, while advantageously maintaining a lower permeation to fluids than is currently obtainable by conventional elastomeric gaskets.

Gaskets of the present invention are multi-layered comprising a core, a barrier, and a conformable outer surface. In one embodiment a resilient core provides compressibility and elasticity to the gasket, while a barrier layer is provided for permeation resistance. An outer layer of the gasket is conformable allowing adequate sealability under low flange loads and low stress conditions to provide low leak rates.

In a preferred embodiment, the resilient core is a low cost synthetic elastomer, with particularly preferred elastomers capable of withstanding a wide range of temperatures. A barrier layer comprised of a low permeating fluoroplastic is preferred, such as polytetrafluoroethylene (PTFE), densified expanded polytetrafluoroethylene (densified ePTFE), fluorinated ethylene-propylene (FEP), perfluoro alkoxy alkane (PFA), tetrafluoroethylene, hexafluoropropylene and vinylidene fluoride terpolymer (THV), ethylene chloro trifluoroethylene (ECTFE), polyvinylidene fluoride (PVDF) and ethylene/tetrafluoroethylene copolymer (ETFE). A preferred conformable outer layer of the gasket such as a fluoroelastomer is applied to the outer surface of the barrier layer. The conformable outer layer provides an impermeable seal upon the application of a relatively low load to the components joined or sealed by the gasket, thereby applying low stress to the gasket. To aid in bonding the outer layer of elastomer to the barrier layer, surface modifiers and adhesives may optionally be used.

### DESCRIPTION OF THE DRAWINGS

FIG. 1 is a perspective view of a sealing ring according to the present invention.

FIG. 2 is a cross sectional view of a sealing ring, taken along line A-A of FIG. 1.

FIG. 3 is a cross sectional view of a sealing ring of the present invention.

FIG. 4 is a cross sectional view of a sealing ring of the present invention.

### DETAILED DESCRIPTION OF THE INVENTION

The present invention is directed to an improved gasket that provides a low leakage seal upon the application of relatively low load and low stress to the components to be joined and which is impermeable, or has low permeability, to liquids and gases. In a preferred embodiment a core material is substantially covered with a barrier layer having low permeability to fluids, and the barrier-covered core is further encapsulated with a comformable outer layer capable of filling in surface irregularities of the sealing surface under low load. Sealability of the gasket is improved even under low flange load sealing conditions.

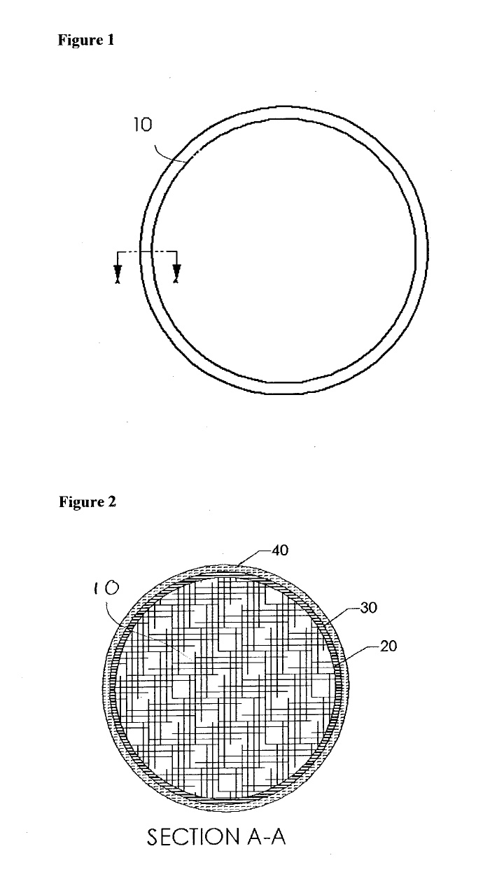

FIG. 1 illustrates one embodiment of the present invention, a seal 10 that is shown as an annular gasket or o-ring. As illustrated in FIG. 2, a cross-section of one seal of the present invention is circular. FIG. 2 illustrates a preferred seal of the present invention comprising a core 20, a barrier layer 30 surrounding the core surface, and an outer layer 40 applied to the barrier layer.

While the gasket of FIG. 1 is annular, it should be understood that the core may alternately be formed into other shapes useful in gasket applications. For use in automotive applications a preferred shape is an o-ring. The cross section of the core and gasket shown in FIG. 2 is circular, however, additionally square, rectangular, H-shaped, or other shaped cross-sections are also contemplated depending upon the application.

Preferred core materials include synthetic rubbers such as nitrile rubber (NBR), hydrogenated nitrile rubber (HNBR), fluoroelastomer such as an FKM elastomer, perfluoroelastomer such as an FFKM elastomer, tetrafluoroethylene and propylene copolymer elastomer (FEPM), silicone rubbers (MQ), fluorosilicone rubber (FMQ), acrylic rubber (ACM), polybutadiene rubber (BR), butyl rubber (IIR), chlorobutyl rubber (CIIR), chlorinated polyethylene elastomer (CPE), epichlorohydrin rubber (ECO), ethylene propylene rubber (EPDM), isoprene rubber (IR), polychloroprene rubber (CR), and styrene butadiene rubber (SBR). Also, preferred are natural rubber (NR) and thermoplastic elastomers (TPE) including polyurethane, polyester, polyether ester, polyolefin, block amide thermoplastic elastomers, and other TPEs, for example, Santoprene® TPE (Advanced Elastomer Systems, Akron, Ohio) and Geolast® TPE (Advanced Elastomer Systems, Akron, Ohio). In addition, the core may be made from foamed or cellular polymers such as polystyrene, vinyl, polyvinyl chloride (PVC), polyethylene (PE) and polypropylene (PP). The core may additionally consist of blends of the preferred materials, for example, a blend of PVC and nitrile rubber.

Less resilient or non-resilient core materials suitable for use in the present invention include but are not limited to plastics, such as PE, PP, PVC, PTFE, FEP, PFA, THV, ETFE, nylon, polysulfone, polyester, vinyl, and acrylic. The core materials may be cured or uncured, filled or unfilled. Fillers may be added to the core material, for example, to increase permeation resistance, flexibility, resiliency, or material strength of the core material or to reduce component cost.

Preferred gaskets have a core that is comprised of “resilient” material, which includes core materials having a compression set of less than about 60% as calculated by ASTM D395, Method B, when tested for about 22 hours at about 70° C., with particularly preferred materials having a compression set of less than about 50% under the same test conditions.

A barrier layer is provided to protect the core against chemical attack and/or to inhibit permeation of chemicals through the seal. The barrier layer has at least one layer and may be provided in any suitable form such as a tape, sleeve, film, co-extruded layer, coating and combinations thereof. Where a multi-layer barrier is formed the layers may be the same or different. The barrier layer may be applied by wrapping, where for example, the barrier is a tape or film; where tape wrapping is used overlapping layers may be formed to produce multiple layers. Where the barrier layer is a coating, the coating may be applied by methods including molding, dip coating, spray coating, ink jet printing, pad printing, vapor deposition, and powder coating. Suitable coating materials include dispersions, emulsions, and solutions, or in molten, liquid or solid form of the barrier material.

Useful barrier materials exhibit low permeation to fluids and have a lower steady state vapor transmission rate (VTR) to a given fluid than the core material. Barrier materials may further exhibit resistance to chemical attack. Suitable barrier materials include metal films and coatings such as vapor deposited metals and foils such as aluminum, metallized films such as aluminum coated polyethylene terephthalate (PET) and aluminum coated polyethylene, fluoropolymers such as PTFE, densified ePTFE, PFA, FEP, PVDF, THV, ETFE, ECTFE, and plastics such as nylon, polyethylene, polypropylene, PVC, polysulfone, polyester, vinyl, and acrylic and combinations thereof. Fluoropolymers with low permeation to, for example, automotive fuels, such as PTFE, densified ePTFE, FEP, PFA, PVDF, ETFE, ECTFE and THV are preferred. In one preferred embodiment, where the gaskets of the present invention are used in fuel systems, preferred barrier materials have a steady state vapor transmission rate (VTR) of from about 0.01 to about 1000 g-mm/m²-day to reference fuel CE10 at 60° C. using test method SAE J6259. Particularly preferred materials have a steady state VTR of about 500 g-mm/m²-day or less to reference fuel CE10 at 60° C. using test method SAE J6259; even further preferred are materials with a steady state VTR of about 100 g-mm/m²-day or less to reference fuel CE10 at 60° C. using test method SAE J6259.

Preferred barrier layers range in thickness from about 1×10⁶ mm in the case of vapor deposited coatings to about 3 mm, with preferred materials ranging from about 0.001 mm to about 1.0 mm, and more preferred gaskets having a barrier layer from about 0.01 mm to about 0.25 mm thick.

The barrier material may be applied to a portion of the core, for example, only in areas needed for permeation resistance. In a preferred embodiment of the present invention, the barrier layer 30 (FIG. 2) completely covers the surface of the core. Where the barrier layer substantially encapsulates the core, permeation of fluids through the cross section of the core may be reduced or eliminated compared to cores without barrier layers. In applications where the gasket core material is incompatible with certain chemicals the barrier layer may also provide resistance from chemical attack and/or constrain the swelling of the core.

In a further embodiment, the barrier layer may be a composite having more than one component, such as a coated or laminated film. A composite film may function as a carrier, for example, a fluoropolymer coating on a polyester film. A composite may also function as a reinforcement, for example, a thermoplastic fluoropolymer layer imbibed into the structure of an ePTFE reinforcing substrate. In one embodiment, one component of a composite barrier layer may function to resist permeation to liquids and gases and another component of the composite may function as an adhesive to bond multiple or overlapping barrier layers together into a continuous barrier layer. A preferred barrier layer is a composite of a low permeating fluoroplastic such as densified ePTFE and a low melt fluoroplastic, such as THV. A continuous barrier layer may be formed when a gasket having the composite barrier layer is taken above the melt temperature of the low melt fluoroplastic.

Adhesives and other surface modifications to the core may optionally be used. For example, surface modifiers and adhesives may be used to aid in bonding the barrier layer to the core. If a composite barrier layer is used, one component of the barrier layer may act as an adhesive to bond the barrier layer to the elastomer core. After the barrier layer is applied to the elastomer core, it may be heat treated above the melt temperature of the barrier material to create a continuous barrier layer by fusing overlapping or multiple barrier layers.

The outer layer 40 (FIG. 2) is conformable, enabling the gasket to seal with relatively low load. Moreover, the conformable outer layer fills in surface irregularities of the sealing surface, lowering the sealing stress necessary to reduce leakage of fluids around the seal. Preferred conformable materials have a durometer of about 80 Shore A and less, as measured by ASTM D2240 using a ten (10) second contact time, with most preferred materials having a durometer of about 70 Shore A and less, as measured by ASTM D2240 using a 10 second contact time. At least one outer layer may be applied to the barrier layer by molding, tape wrapping, co-extrusion, dip coating, spray coating, ink jet printing, pad printing, vapor deposition, powder coating, or other application methods. Outer layer coating material may be a dispersion, emulsion, solution, molten, liquid or solid form. The thickness of the preferred conformable outer layer may range from about 0.001 mm to about 3 mm thick, more preferably from about 0.005 mm to about 1 mm thick, and further preferred from about 0.01 mm to about 0.25 mm thick.

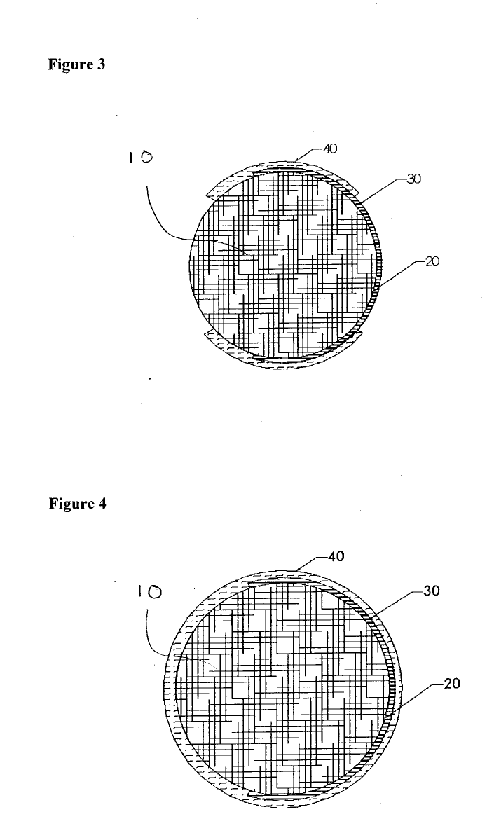

The outer layer preferably completely covers the surface of the barrier layer. Preferably the conformable outer layer substantially completely covers the barrier-covered core material including any portion of the core in which no barrier layer was applied (FIG. 4). Alternately, the outer layer may be applied only in areas needed for forming a seal. FIG. 3 illustrates one example of a conformable outer layer covering at least a portion of the barrier-covered core material.

The conformable outer layer preferably comprises synthetic elastomers including but not limited to nitrile rubber (NBR), hydrogenated nitrile rubber (HNBR), fluoroelastomers such as FKM elastomers, perfluoroelastomers such as FFKM elastomers, tetrafluoroethylene and propylene copolymer elastomer (FEPM), silicone rubbers (MQ), fluorosilicone rubber (FMQ), acrylic rubber (ACM), polybutadiene rubber (BR), butyl rubber (IIR), chlorobutyl rubber (CIIR), chlorinated polyethylene rubber (CPE), epichlorohydrin rubber (ECO), ethylene propylene rubber (EPDM), isoprene rubber (IR), polychloroprene rubber (CR), and sytrene butadiene rubber (SBR). Also, preferred are natural rubber (NR) and thermoplastic elastomers (TPE) including polyurethane, polyester, polyether ester, polyolefin, block amide thermoplastic elastomers, and other TPEs, for example, Santoprene® TPE (Advanced Elastomer Systems, Akron, Ohio) and Geolast® TPE (Advanced Elastomer Systems, Akron, Ohio), and combinations thereof. The conformable outer layer may also include other conformable polymers such as ePTFE and foamed or cellular polymers such as polystyrene, vinyl, poly vinyl chloride (PVC), polyethylene (PE) and polypropylene (PP).

Fillers may be added to outer layer material; for example, non-conformable material may be added to increase material strength of the outer layer, or fillers may be added to increase the permeation resistance of the outer layer. Fillers may also be added to increase flexibility, increase resiliency or reduce the cost of the gasket. The outer layer may also be a blend of preferred materials, for example, a blend of FEP and NBR. In a preferred embodiment, the outer layer is both a conformable and low permeating elastomer such as FKM fluoroelastomer or FFKM perfluoroelastomer.

Surface modifications and adhesives may optionally be used prior to the application of the conformable outer layer. For example, a surface modifier such as Tetra-etch® (W. L. Gore & Assoc., Newark, Del.) may be applied to the outer layer to increase the adhesion of the outer layer to the barrier layer. Other suitable surface modifications include plasma treating, flame treating, and corona treating. An adhesive primer may be applied to the barrier layer before the outer layer is applied to increase adhesion of the outer layer to the barrier layer, either as an alternative to, or in addition to other surface modifications. Chem Lok® 5151 (Lord Corp., Cary, N.C.) is an example of a preferred adhesive primer.

Preferred impermeable, sealable gaskets of the present invention comprising a core, a barrier and an outer layer seal well upon the application of low flange loads. Preferred gaskets have a leak rate of less than about 5 ml/hr, more preferably about 2 ml/hr or less, and most preferably about 1 ml/hr or less under a flange load of about 300 lbf (1334 newtons). Most preferably gaskets have a leak rate of less than about 5 mL/hr, about 2 mL/hr or less, or about 1 mL/hr or less at flange loads less than about 200 lbf (889 newtons), and even further preferred flange loads at about less than about 150 lbf (667 newtons).

While low flange load generally results in low stress to the gasket, preferred are gaskets having a leak rate of less than 5 mL/hr when the gasket is subjected to a sealing stress of about 300 psi (2.1 MPa) or less, and more preferably at a sealing stress of about 200 psi (1.4 MPa) and most preferred, about 150 psi (1.0 MPa) or less. Further preferred are gaskets having a leak rate of less than about 2 mL/hr upon an average sealing stress of about 300 psi (2.1 MPa) or less, more preferably at about 200 psi (1.4 MPa) or less, and most preferred when a sealing stress of about 150 psi (1.0 MPa) or less is applied. Further preferred are gaskets having a leak rate of about 1 mL/hour or less, upon the application of a sealing stress of about 300 psi (2.1 MPa) or less, more preferably at about 200 psi (1.4 MPa) or less, and further preferred, about 150 psi (1.0 MPa) or less. Leak rates are determined by testing according to the sealability test method described herein with the gasket being internally pressurized to about 5 psi (34.5 kPa) of air at about 23° C. using the procedures and equipment outlined in ASTM F37-95 Test Method B.

A specific preferred embodiment of the present invention as illustrated by FIG. 2 is a seal that reduces emissions in a fuel system and that is resistant to permeation of liquid or vapor fuel through the gasket, and that further seals well under the application of low flange load and low stress sealing conditions. A preferred gasket suitable for achieving the above uses is an o-ring comprising an elastomeric, resilient core selected from natural and synthetic rubbers, and thermoplastic elastomers, and a barrier layer which substantially covers the entire core material. The preferred barrier material for this application is PTFE, densified ePTFE, FEP, and THV, having a coefficient of permeation of less than about 500 g-mm/m2-day to reference fuel CE10 at 60° C. using test methods SAE J6259. A preferred conformable outer layer substantially encapsulates the barrier-covered core and contributes to the low stress and low flange load to seal characteristics of the gasket, and is a fluoroelastomer or a perfluoroelastomer. Preferred o-rings of the present invention have a low stress to seal, having a leak rate of 2 mL/hr or less_under a sealing stress of about 200 psi (1.4 Mpa) or less. Thus, one method of use of the present invention is a method of reducing the emission of liquid or vapor fuel from a system comprising providing a gasket, such as an o-ring as described herein, to a fuel system.

The present invention is further directed to a method for preparing a gasket as described above, the method steps comprising providing a core, covering at least a portion of the core with a barrier layer, and providing an outer layer on at least a portion of the barrier material. The core, barrier layer and outer layer are selected from materials as described herein. Optionally a heating step may be performed after the barrier layer has been applied. For example, where more than one barrier layer has been applied or where the barrier layer is applied by overlapping tape wrapping, the gasket may be heated until the layers are adhered together, or until a continuous barrier layer is formed. Further, surface modification steps, or steps for applying an adhesive optionally may be included prior to the application of the barrier layer or outer layer.

While the invention is not intended to be limited by the following examples, the present invention may be better understood by them. In the examples, the following test methods were used.

### TEST METHODS

Sealability

Sealability was determined by leak rate tests performed in accordance with procedures and equipment outlined in ASTM F37-95 Test Method B, which is suitable for measuring leakage rates in the range of about 6 L/hr to about 0.3 mL/hr. The sealing force selected was about 150 lbs. (667 newtons), which is the force required to compress an AS-568A Size 337 (75.6 mm ID, about 5.3 mm cross section) FKM o-ring gasket about 25%. The test fluid was air at about 34.5 kPa (5 psi). The gaskets were loaded to the selected compressive force between two flat lathed stainless steel sealing surfaces with and average surface roughness of about 1.0 μm or greater tangentially to the machining marks, and about 2.0 μm or greater perpendicular to the machining marks. The surface roughness values were obtained through the use of a Mitutoyo Surftest-211 surface roughness measuring instrument (Mitutoyo America Corp., Aurora, Ill.).

The gaskets were then subjected to about 34.5 kPa (5 psi) internal air pressure introduced into the center of the compressed gasket. The air pressure within the test assembly was isolated from the environment by closing a valve. The gaskets were held at room temperature for about 5 minutes to allow the leakage to reach steady state. The pressure drop was measured with an electronic pressure sensor located in the line upstream from the gasket test fixture. The pressure drop in the gasket was due to air leakage past the gasket resulting in loss of internal air pressure. The pressure drops were converted to leakage rates using the equation below:

$$LR = \frac{V * mw}{δ * t * R * T} ( {p}_{1} - {p}_{2} )$$

where:

LR is the leak rate of the air in mL/hr

V is the volume inside the o-ring in m₃

mw is the molecular weight of the air in kg/kmol

δis the density of the air in kg/mL

t is the time in hr

R is the universal gas constant in J/kmol*K

T is the temperature in K

p₁ is the initial air pressure in Pa

P₂ is the final air pressure in Pa.

During each test, the compressed height of each gasket was measured by inserting feeler gauges between the sealing plates. The compressive force was then converted into an approximate average sealing stress for each gasket using the equation below:

$$SS = \frac{4 * F * Σ}{{π}^{2} * D * ( 4 {r}^{2} - {Σ}^{2} )}$$

Where:

SS is the average sealing stress on the gasket

F is the compressive force on the gasket

Σis the compressed height of the gasket

πis a constant

D is the mean diameter of the gasket

r is the cross sectional radius of the gasket

### EXAMPLES

### Comparative Example 1

AS-568A size 337 (about 75.6 mm internal diameter, 5.3 mm cross section) FKM elastomer o-rings were obtained from (McMaster-Carr, Dayton, N.J.). Three samples were tested according to the Sealability test method described above. The results were averaged between the three samples. The sealability results, reported as leak rate, can be seen in Table 1.

### Comparative Example 2

An o-ring comprising an NBR rubber core wrapped with a densified ePTFE/THV tape was prepared and tested for sealability.

An extruded NBR rubber cord was obtained (AMS-R-6855A, class 1, grade 60 from AAA-Acme Rubber, Tempe, Ariz.) having a cross section of about 0.205 in (5.2 mm). The durometer of the cord was about 50, Shore A. The rubber cord was placed in an oven for about an hour at 140° C. to remove volatile components of the elastomer. The rubber cord was wrapped helically with a barrier layer consisting of a composite tape constructed of one layer of low permeating densified ePTFE with a thickness of about 0.005 mm and one layer of THV 500 (Dyneon Corp., Oakdale, Minn.) with a thickness of about 0.005 mm. The final dimensions of the composite tape was about 0.01 mm thick by about 12.7 mm wide. The rubber cord was wrapped helically with the composite tape producing six (6) layers of composite tape measuring a total of 0.06 mm thick.

The wrapped cord was cut into segments and the ends of the segment were bonded with a temperature resistant Scotch Weld® 2216 B/A two part epoxy (3M Corp., St. Paul, Minn.) which was applied to the ends of the segments forming a ring with about a 75.5 mm internal diameter. The cord was then placed in a mold with the ends touching and the cord/mold assembly was placed in an oven at about 90° C. for about 2 hours to bond the ends. The densified ePTFE/THV 500 composite tape was wrapped twice around the bond area to reinforce it. The cord was placed in a mold and the cord/mold assembly was placed in an oven at about 180° C. for about 2 hours, melting the thermoplastic component of the composite film. When removed from the heat, a continuous composite barrier layer was formed.

The sample was cooled and tested for sealability using the test method described above. Three samples were prepared and tested substantially according to this example. The results were averaged between the three samples. The sealablity results, reported as leak rate, can be seen in Table 2.

### Comparative Example 3

AS-568A Size 337 (75.6 mm ID, about 5.3 mm cross section) o-rings of FKM encapsulated with (FEP) were obtained (McMaster-Carr, Dayton, N.J.), and tested for sealability.

Encapsulated o-rings were manufactured by co-extruding FEP fluoroplastic over a resilient FKM elastomer core. The encapsulated o-ring was tested according to the above test method. The sealability test was repeated for a total of three samples. The results were averaged between three samples. The sealability results, reported as leak rate, can be seen in Table 2.

### Example 4

An o-ring comprising an NBR rubber core wrapped with densified ePTFE/THV was prepared having a conformable outer layer.

Tetra-Etch® surface modifier (W. L. Gore & Assoc., Newark, Del.) was applied to the surface of the barrier layer of a wrapped o-ring prepared substantially according to Comparative Example 2. The residue was wiped clean with paper towels and wetted with isopropyl alcohol. ChemLok® 5151 adhesive (Lord Corp., Cary, N.C.) was applied over the etched barrier, and allowed to dry. A solvent based liquid FKM elastomer, Pelseal PLV 6032, (Pelseal Labs, Newtown, Pa.) was sprayed with an air spray gun over the prepared surface forming a layer of about 0.07 mm using multiple passes of the spray gun. The samples were allowed to air dry for about 24 hrs.

The dried samples were tested for sealability according to the above test method. The sealability test was repeated for three samples. The results were averaged between the three samples. The sealability results, reported as leak rate, can be seen in Table 1 and Table 2.

TABLE 1

| Ex- | | Sealing | Pressure | Time | Leak Rate |
|---|---|---|---|---|---|
| ample | Flange Load | Stress (MPa) | Drop (Pa) | (hr) | (mL/hr) |
| 1 | 667 N (150 lbs.) | 1.0 | 0 | 1 | <0.3 |
| 4 | 667 N (150 lbs.) | 0.9 | 0 | 1 | <0.3 |

Table 1 illustrates enhanced sealing properties of gaskets of the present invention. Under low flange load and low stress conditions, gaskets produced according to Example 4 had similar leak rates when compared to the FKM elastomer o-ring of Example 1 which have low leakage under low flange load applications but little resistance to permeation by certain fluids.

TABLE 2

| | | Stress | | | |
|---|---|---|---|---|---|
| | | (Mpa) | Drop (Pa) | Time | (mL/hr) Leak |
| Example | Flange Load | Sealing | Pressure | (hr) | Rate |
| 2 | 667 N (150 lbs) | 1.2 | 32700 | 0.25 | 28.8 |
| 3 | 667 N (150 lbs) | 1.4 | 15375 | 1 | 3.5 |
| 4 | 667 N (150 lbs) | 0.9 | 0 | 1 | <0.3 |

Table 2 illustrates the sealing performance of gaskets of the present invention when compared to other permeation resistant seals. Gaskets made according to Example 4 had substantially lower leak rates upon the application of low load and low stress sealing conditions than seals made according to Examples 2 and 3 which are used in barrier applications.

We claim:

1. A gasket comprising
a core,
a barrier layer substantial encapsulating the core, and
a conformable outer layer having a durometer of less than or equal to 80 Shore A, on at least a portion of the barrier material.

2. The gasket of claim 1, wherein the gasket is annular.

3. The gasket of claim 1, wherein the core is resilient.

4. The gasket of claim 3, wherein the resilient core has a cross-section selected from the shape circular, oval, square, rectangular, and H-shaped.

5. The gasket of claim 3, wherein the resilient core has a compression set of less than 60%.

6. The gasket of claim 1, wherein the outer layer has a thickness of from about 0.00mm to about 3 mm.

7. The gasket of claim 1, wherein the outer layer has a thickness of about 0.01 mm to about 0.25 mm.

8. A gasket comprising
a core
a barrier layer on at least a portion of the core, and
a conformable outer layer on at least a portion of the barrier, wherein the gasket has a leak rate about 2 mL/hr or less when the gasket is internally pressurized to about 5 psi (34.5 kPa) of air at 23° C. upon a sealing stress of about 300 psi or less.

9. The gasket of claim 8, having a leak rate of about 1 mL/hr or less when the gasket is internally pressurized to about 5 psi (34.5 kPa) of air at 23° C.

10. The gasket of claim 8, having a leak rate of about 2 mL/hr or less upon a sealing stress of about 200 psi or less.

11. The gasket of claim 8, having a leak rate of about 2 mL/hr or less upon a sealing stress of about 150 psi or less.

12. The gasket of claim 8, wherein the barrier layer has a steady state vapor transmission rate of about 0.1 to about 1000 g-mm/m2-day to reference fuel CE 10.

13. The gasket of claim 8, wherein the barrier layer has a steady state vapor transmission rate of less than about 500 g-mm/m2-day to reference fuel CE10.

14. A gasket comprising
a core
a barrier layer on at least a portion of the core, and
a conformable outer layer on at least a portion of the barrier layer, wherein the gasket has a leak rate about 2 mL/hr or less when the gasket is internally pressurized to about 5 psi (34.5 kPa) of air at 23° C. upon a flange load of about 300 lbf or less.

15. The gasket of claim 14, wherein the flange load is about 200 lbf or less.

16. The gasket of claim 14, wherein the flange load is about 150 lbf or less.

17. The gasket of claim 14, having a leak rate of about 1 mL/hr or less when the gasket is internally pressurized to about 5 psi (34.5 kPa) of air at 23° C.

18. The gasket of claim 14, wherein the barrier layer has a steady state vapor transmission rate less than the core material.

19. The gasket of claim 14, wherein the barrier layer has a steady state vapor transmission rate of about 0.1 to about 1000 g-mm/m2-day to reference fuel CE 10.

20. The gasket of claim 14, wherein the barrier layer has a coefficient of steady state vapor transmission rate of less than about 1000 g-mm/m2-day to reference fuel CE10.

21. The gasket of claim 14, wherein the barrier layer has a steady state vapor transmission rate of less than about 500 g-mm/m2-day to reference fuel CE10.

22. A gasket comprising
a core
a barrier layer comprised of a synthetic fluoropolymer or metallized film on at least a portion of the core, and
a conformable outer layer comprised of synthetic elastomers, natural rubber, or thermoplastic elastomers, covering the barrier layer.

23. The article of claim 22, wherein the core is resilient and comprises a material selected from natural rubber, synthetic rubber, thermoplastic elastomer and combinations thereof.

24. The article of claim 23, wherein the resilient core comprises a material selected from fluoroelastomer and nitrile rubber.

25. The article of claim 22, wherein the resilient core is a foamed polymer.

26. The gasket of claim 22, wherein the barrier layer covers only a portion of the core needed for permeation resistance.

27. The gasket of claim 22, wherein the core is substantially encapsulated by the barrier layer.

28. The gasket of claim 22, wherein the barrier layer is in the form of a tape, sleeve, film, coextruded layer or coating.

29. The gasket of claim 22, wherein the barrier layer is a fluoropolymer selected from polytetrafluoroethylene, densified expanded polytetrafluoroethylene, fluorinated ethylene-propylene, and tetrafluoroethylene, hexafluoropropylene and vinylidene fluoride terpolymer, and combinations thereof.

30. The gasket of claim 22, wherein the barrier layer is a composite comprising a fluoropolymer.

31. The gasket of claim 30, wherein the barrier layer is a composite of densified ePTFE and at least one other component.

32. The gasket of claim 22, wherein the outer layer is selected from nitrile rubber, fluoroelastomer, perfluoroelastomer, tetrafluoroethylene and propylene copolymer elastomer, and fluorosilicone rubber.

33. The gasket of claim 22, wherein the outer layer is selected from fluoroelastomer and perfluorelastomer.

34. The gasket of claim 32, wherein the outer layer is selected from FKM and FFKM elastomers.

35. The gasket of claim 22, wherein the outer layer further comprises a filler.

36. The gasket of claim 35, wherein the filler comprises fluorinated ethylene-propylene or polytetrafluoroethylene.

37. The gasket of claim 35, wherein the outer layer is expanded polytetrafluoroethylene imbibed with and elastomer.

38. The gasket of claim 22, further comprising an adhesive between the barrier and the outer layer.

39. The gasket of claim 22, wherein the core is a nitrile rubber or an FKM elastomer, the barrier layer is a composite of densified expanded polytetrafluoroethylene and THV, and the outer layer is a fluoroelastomer or a perfluoroelastomer.

40. A method of making a gasket comprising
providing a resilient core material,
covering the resilient core material with a barrier material having a lower steady state vapor transmission rate than the resilient core material, to form a covered core, and encapsulating the covered core material with a outer layer.

41. The method of claim 40, further comprising applying an adhesive to bond the barrier to the resilient core material.

42. The method of claim 40, further comprising heating the covered core above the melt temperature of the barrier material.

43. The method of claim 40, further comprising modifying the surface of the barrier material prior to encapsulating.

42. The method of claim 40, wherein covering comprises wrapping or molding.

43. The method of claim 40, wherein encapsulating comprises molding, wrapping, dip coating or spraying.
